(19) United States
(12) Patent Application Publication
(10) Pub. No.: US 2006/0171471 A1
(43) Pub. Date: Aug. 3, 2006

(54) Random access in AVS-M video bitstreams

(76) Inventor: Minhua Zhou, Plano, TX (US)

Correspondence Address: TEXAS INSTRUMENTS INCORPORATED, P O BOX 655474, M/S 3999, DALLAS, TX, 75265, US

(21) Appl. No.: 11/344,717

(22) Filed: Feb. 1, 2006

Related U.S. Application Data
(60) Provisional application No. 60/648,727, filed on Feb. 1, 2005.

(51) Int. Cl. H04N 11/02; H04N 11/04; H04N 7/12; H04B 1/66

(52) U.S. Cl. 375/240.25; 375/240.01

(57) ABSTRACT

Random access indicator as a nal_unit_type in video compressed with AVS-M for an access unit not requiring prior access unit information for decoding an IDR.

### CROSS-REFERENCE TO RELATED APPLICATIONS

This application claims priority from provisional patent application No. 60/648,727, filed Feb. 1, 2005.

### BACKGROUND OF THE INVENTION

The present invention relates to video coding.

In the AVS-M video compression standard of China, a compressed video bitstream is made up of Access Units (AUs), and each AU contains information for decoding a picture. An AU consists of a number of NAL (Network Abstraction Layer) units, some of which are optional. As shown in FIG. 1, a NAL unit can be a sequence parameter set (SPS), a picture parameter set (PPS), an SEI (Supplemental Enhancement Information), a picture header, or a slice_layer_rbsp (raw byte sequence payload) which consists of a slice_header followed by slice data (i.e. a number of macroblocks, where a macroblock contains 16×16 luminance block and corresponding two 8×8 chrominance blocks for 4:2:0 chroma format). In the byte-format bitstream, a NAL unit starts with 3-byte start-code (0x000001) followed by a 1-byte NAL unit indicator in which nal_unit_type is represented in a 5-bit field; see FIG. 2.

For decoding a picture in AVS-M (see FIG. 1), an AU contains optional SPS, PPS, SEI NAL units followed by a mandatory picture header NAL unit and several slice_layer_rbsp NAL units. Note that in H.264 and AVS-M decoding a picture (an AU) may need SPS, PPS information, et cetera, from preceding AUs.

There is a drawback in the current AVS-M Access Unit structure definition, which is a lack of bitstream random access support. In order to determine whether the decoding can start from an arbitrary AU (see FIG. 1 as example), the decoder has to parse the bitstream byte-by-byte to the first slice_data_rbsp NAL unit to check whether the current picture is an IDR (Instantaneous Decoding Refresh) picture. If it is not an IDR picture, the decoder continues byte-by-byte parsing until such an IDR picture is found. If it is an IDR picture, the decoder decodes the slice_header to determine which SPS and PPS information (there are 16/128 SPS/PPS in AVS-M) is used for decoding the current picture, then goes back to the position in the bitstream where the required SPS/PPS can be decoded. Note that the required SPS/PPS used for decoding the current IDR picture is not necessarily contained in the current AU, the decoder may need to go back a couple of AUs to find them. This makes the parsing process very complex.

An alternative to avoid going back to find the required SPS/PPS is to decode and buffer all the SPS/PPS and picture headers whenever they are found during the byte-by-byte bitstream parsing. In this case the decoding can start at the first slice_data_rbsp NAL unit when an IDR picture is found, there is no need for going back to find the required SPS/PPS because they are already available. However, decoding and buffering SPS/PPS will significantly decrease the bitstream parsing speed.

Hence, there is a need to find a way to support easy random access in the AVS-M standard. Random access is needed for applications like TV broadcasting (receivers may turn on at any time) and fast forward/fast backward functions in video playback.

### SUMMARY OF THE INVENTION

The present invention provides a method of enabling easy random access in AVS-M video bitstreams by insertion of random access units.

### BRIEF DESCRIPTION OF THE DRAWINGS

FIG. 1 illustrates decoding an access unit.

FIG. 2 shows the first four bytes of a NAL unit.

FIG. 3 illustrates decoding an access unit including a random access indicator.

### DESCRIPTION OF THE PREFERRED EMBODIMENTS

1. Overview

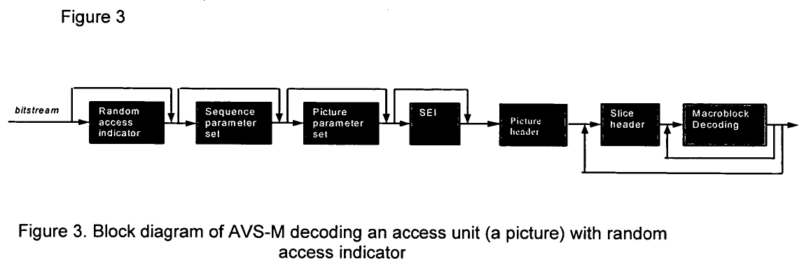

Preferred embodiment methods enable easy random access in AVS-M video bitstreams by providing a random access indicator in the nal_unit_type field for access units (AUs) where prior Access Unit information is not needed for decoding an IDR. FIG. 3 shows the random access indicator (RAI) in a decoding sequence.

Preferred embodiment systems perform preferred embodiment methods with any of various types of hardware: digital signal processors (DSPs), general purpose programmable processors, application specific circuitry, or systems on a chip (SoC) such as both a DSP and RISC processor on the same chip. A stored program in an onboard ROM or external flash EEPROM for a DSP or programmable processor could perform the signal processing for the encoding and decoding. Analog-to-digital converters and digital-to-analog converters provide coupling to the real world, and modulators and demodulators (plus antennas for air interfaces) provide coupling for transmission waveforms. The encoded video can be packetized and transmitted over networks such as the Internet.

2. First Preferred Embodiment

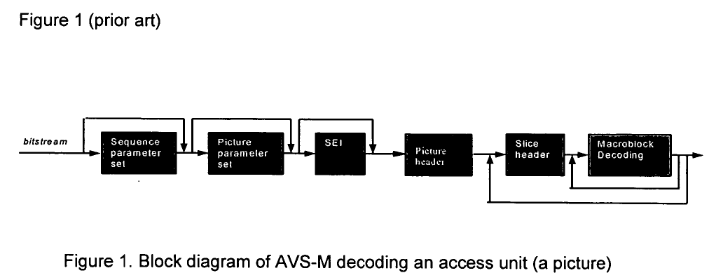

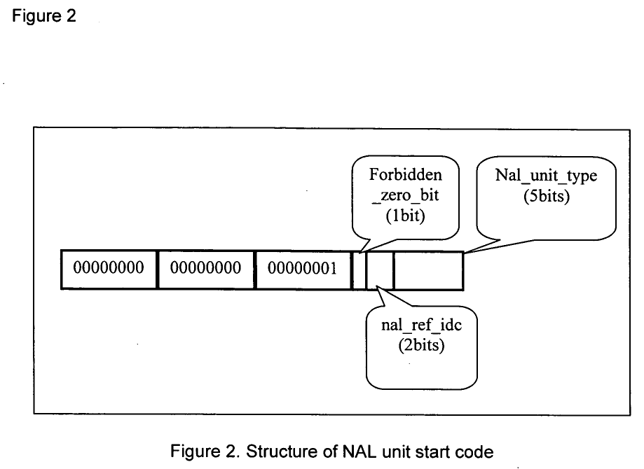

In the AVS-M video compression standard of China, a compressed video bitstream is made of Access Units (AUs), each AU contains information for decoding a picture. An AU consists of a number of NAL (Network Abstraction Layer) units, some of which are optional. As shown in FIG. 1, a NAL unit can be a sequence parameter set (SPS), a picture parameter set (PPS), an SEI (Supplemental Enhancement Information), a picture header, or a slice_layer_rbsp (raw byte sequence payload) which consists of a slice_header followed by slice data (i.e. a number of macroblocks, where a macroblock contains 16×16 luminance block and corresponding two 8×8 chrominance blocks for 4:2:0 chroma format). In the byte-format bitstream, a NAL unit starts with the 3-byte start-code 0x000001 followed by a 1-byte NAL unit indicator in which the first bit is forbidden_zero_bit, the next two bits are nal_ref_idc, and the remaining 5-bit field is nal_unit_type; see FIG. 2.

For decoding a picture in AVS-M (see FIG. 1), an AU contains optional SPS, PPS, SEI NAL units followed by a mandatory picture header NAL unit and several slice_layer_rbsp NAL units. Note that in both H.264 and AVS-M decoding a picture (an AU) may need SPS, PPS information, et cetera, from preceding AUs.

There is a drawback in the current AVS-M Access Unit structure definition, which is a lack of bitstream random access support. In order to determine whether the decoding can start from an arbitrary AU (see FIG. 1 as an example), the decoder has to parse the bitstream byte-by-byte to the first slice_data_rbsp NAL unit to check whether the current picture is an IDR (Instantaneous Decoding Refresh) picture. If it is not an IDR picture, the decoder continues byte-by-byte parsing until such an IDR picture is found. If it is an IDR picture, the decoder decodes the slice_header to determine which SPS and PPS information (there are 16/128 SPS/PPS in AVS-M) is used for decoding the current picture, then goes back to the position in the bitstream where the required SPS/PPS can be decoded. Note that the required SPS/PPS used for decoding the current IDR picture is not necessarily contained in the current AU, the decoder may need to go back a couple of AUs to find them. This makes the parsing process very complex.

As shown in FIG. 3, the preferred embodiment methods define a new NAL unit type named “Random Access Indicator” (RAI) for AVS-M. The first three bytes are start-code, the last byte includes the RAI NAL unit indicator in the last 5-bit nal_unit_type field; see FIG. 2. The nal_unit_type value for RAI can be assigned to any value that is still reserved in the AVS-M; e.g., 8.

The appearance of RAI NAL units is optional. If random access is not a requirement, the encoder can choose not to insert any RAI NAL units in the bitstream. On the hand, for applications like mobile TV broadcasting in which random access is a requirement, the encoder inserts an RAI NAL unit as the first NAL unit of an access unit (as in FIG. 3) only if the current access unit is an random access point (i.e., the current picture is an IDR picture, and its decoding does not refer to information from any other access units). In this way, the decoder can easily do random access by searching for the RAI NAL unit byte-by-byte.

What is claimed is:

1. A method of video encoding, comprising:
(a) providing access units in a bitstream, wherein said access units contain network abstraction layer (NAL) units which include video compression information, and
(b) including a random access indicator (RAI) NAL unit in an access unit which can be decoded without information from preceding access units.

2. The method of claim 1, wherein:
(a) said NAL units contain a start code and a nal_unit_type field; and
(b) said RAI NAL units have a random access indicator in said field.

3. A method of video decoding, comprising:
(a) receiving a bitstream with access units, wherein said access units contain network abstraction layer (NAL) units which include video compression information, and
(b) finding a random access point in said bitstream by parsing until a random access indicator (RAI) NAL unit is found; and
(c) decoding an access unit containing said RAI NAL.

4. The method of video decoding of claim 4, wherein:
(a) said NAL units contain a start code and a nal_unit_type field; and
(b) said RAI NAL units have a random access indicator in said field.

5. A NAL unit structure for AVS-M video coding, comprising:
(a) a start code; and
(b) a random access indicator in a nal_unit_type field.

6. The structure of claim 6, wherein:
(a) said start code is 0x000001; and
(b) said nal_unit_type field in a byte immediately following said start code.
